(19) United States
(12) Patent Application Publication
(10) Pub. No.: US 2012/0092214 A1
(43) Pub. Date: Apr. 19, 2012

(54) METHOD OF RECEIVING GNSS SIGNAL AND APPARATUS THEREOF

(75) Inventors: Ho Jin LEE, Daejeon-si (KR); Myung Soon Kim, Daejeon-si (KR); Sang Uk Sang, Daejeon-si (KR); Seung Hyun Choi, Daejeon-si (KR); Do Seob Ahn, Daejeon-si (KR)

(73) Assignee: ELECTRONICS AND TELECOMMUNICATIONS RESEARCH INSTITUTE, Daejeon (KR)

(21) Appl. No.: 13/275,906

(22) Filed: Oct. 18, 2011

(30) Foreign Application Priority Data
Oct. 19, 2010 (KR) 10-2010-0102152

(51) Int. Cl. G01S 19/42; G01S 19/52; G01S 19/37; G01S 19/24

(52) U.S. Cl. 342/357.25; 342/357.63; 342/357.35; 342/357.77

(57) ABSTRACT

A method of receiving a global navigation satellite system (GNSS) signal in a GNSS reception apparatus is provided. The method includes the steps of: measuring channel quality for each frequency band; selecting a plurality of reception channels by using the measured channel quality; reconfiguring an operating parameter of the reception apparatus in accordance with the reception channel; and receiving a signal by using the reconfigured operating parameter.

### CROSS-REFERENCE TO RELATED APPLICATIONS

This application claims the benefit of priority of Korean Patent Application No. 10-2010-0102152 filed on Oct. 19, 2010 which are incorporated by reference in their entirety herein.

### BACKGROUND

1. Technical Field

The present invention relates to a wireless communication technique, and more particularly, to a method of effectively receiving a global navigation satellite system (GNSS) signal and an apparatus thereof.

2. Related Art

A global positioning system (GPS) satellite of the United States has conventionally been used as only an artificial satellite (hereinafter simply referred to as a satellite) that can be used by a typical reception apparatus located on the ground as a global navigation satellite system (GNSS). However, GALILEO of the European Union, global navigation satellite system (GLONASS) of Russia, COMPASS of China, QZSS of Japan, and the like have recently been used or are expected to be used in the near future.

The use of various GNSSs results in the development of a new environment where positioning is possible by using a method which is more precise and suitable for a desired purpose. The environment is expected to be developed in the future to an environment not dependent on one system and an environment where various and independent GNSSs exist. Therefore, to cope with this trend, it is expected that the GNSS will be continuously diversified.

Accordingly, a GNSS signal reception apparatus supporting various GNSSs is required. At present, a user terminal has a structure in which a plurality of hardware (H/W) platforms are integrated together to support all of various communication protocols and frequencies used in the respective GNSSs.

FIG. 1 is a block diagram showing the conventional GNSS signal reception apparatus.

GNSS signals received by a radio frequency (RF) unit 105 through an antenna 100 are processed in signal processing units 110 implemented in parallel and corresponding to respective basebands. The GNSS signal processed in each signal processing unit 110 is used in a positioning unit 115 to perform positioning of the GNSS signal reception apparatus.

Among the individual signal processing units 110 implemented in parallel, a specific signal processing unit operationally required is manually selected by an external means.

As shown in FIG. 1, independent hardware platforms corresponding to respective GNSSs/frequency bands are embedded in the conventional GNSS signal reception apparatus to support various GNSSs. That is, baseband signals are different from one another in general due to a difference of the respective GNSSs. Therefore, in order to use the various GNSSs, each GNSS has to employ a suitable GNSS signal reception apparatus. When one GNSS signal reception apparatus is used to support the various GNSSs, independent hardware platforms corresponding to respective GNSSs/frequency bands have to be embedded in the reception apparatus.

The GNSS signal reception apparatus receives a GNSS signal by using a hardware platform supporting a GNSS in use. Such a parallel hardware type GNSS signal reception apparatus has a disadvantage in that its implementation is significantly complex and its size increases significantly to employ respective independent hardware platforms. In addition, individual installations of the respective independent hardware platforms lead to a burden in terms of costs, and independent operations of the respective hardware platforms lead to great power consumption and difficulty in effectively dealing with noise and jamming.

Further, since new hardware platforms have to be installed to support a new GNSS, there is a limitation in that not all of newly introduced GNSSs can be supported. Furthermore, given that the GNSS is supported in a hardware level, in order to fix a bug of the conventional system or to add a new function to the conventional system, some or all of hardware platforms are newly designed, thereby resulting in user inconvenience.

### SUMMARY

The present invention provides a method of receiving a global navigation satellite system (GNSS) signal with high quality by adaptively coping with a channel environment.

The present invention also provides a method of reliably receiving a GNSS signal by adaptively coping with a channel environment.

The present invention also provides a method capable of saving manufacturing and operating costs of a reception apparatus by reconfiguring a software defined radio (SDR)-based reception apparatus.

The present invention also provides a method capable of significantly reducing power consumption of a reception apparatus by reconfiguring an SDR-based reception apparatus.

According to an aspect of the present invention, a method of receiving a GNSS signal in a GNSS reception apparatus is provided. The method includes the steps of: measuring channel quality for each frequency band; selecting a plurality of reception channels by using the measured channel quality; reconfiguring an operating parameter of the reception apparatus in accordance with the reception channel; and receiving a signal by using the reconfigured operating parameter.

In the aforementioned aspect of the present invention, the method may further include the steps of: measuring quality of the reception channel through which the signal is received; and determining whether a signal reception state is reliable. If the reception channel′ channel quality measured in the step of measuring the quality of the reception channel is less than a first threshold, returning to the step of measuring channel quality for each frequency band, the respective steps may be repeated. If the reception state is determined to be reliable in the step of determining the stability of the signal reception state, the signal may be received by selecting one reliable channel from the reception channels.

In addition, the method may further include the step of measuring channel quality for the reliable channel. If the measured channel quality of the reliable channel is less than a second threshold, returning to the step of measuring channel quality for each frequency band, the respective steps may be repeated.

In addition, a period of measuring the channel quality of the reliable channel may be determined according to a moving speed of the reception apparatus.

In addition, the channel quality of the reliable channel may be determined by measuring a signal to noise ratio of the channel.

In addition, if even any one of the reception channels has channel quality less than the first threshold, returning to the step of measuring channel quality for each frequency band, the respective steps may be repeated.

In addition, if channel quality of all of the reception channels is less than the first threshold, returning to the step of measuring channel quality for each frequency band, the respective steps may be repeated. If channel quality of some of the reception channels is less than the first threshold, a reliable channel may be selected from reception channels having channel quality greater than the first threshold.

In addition, quality of the reception channel may be determined by measuring a signal to noise ratio.

In addition, the reliability of the reception state may be determined according to whether a code phase or a carrier phase of the received signal is maintained within a specific reference offset range during a predetermined specific reference time.

In addition, the step of measuring channel quality for each frequency band may be performed for a candidate frequency band which is predetermined according to at least one of criteria including performance of the reception apparatus, a location of the reception apparatus, a previous usage history of the reception apparatus, and a user's preference.

In addition, the step of measuring channel quality for each frequency band may determine channel quality by measuring a carrier-to-noise ratio of the channel for each frequency band.

According to another aspect of the present invention, an apparatus for receiving a GNSS signal is provided. The apparatus includes: a plurality of radio frequency (RF) units for extracting a baseband signal by receiving the GNSS signal; a signal processing unit for processing the baseband signal; a positioning unit for positioning the reception apparatus by using an output value of the signal processing unit; and an SDR-based cognitive engine, wherein the cognitive engine reconfigures the RF unit and the signal processing unit according to a channel environment corresponding to each frequency band of the received signal.

In the aforementioned aspect of the present invention, the cognitive engine may reconfigure the RF unit and the signal processing unit by reconfiguring an operating parameter of the GNSS reception apparatus.

In addition, the cognitive engine may determine quality of a reception channel through which the reception apparatus receives a signal, and if the quality of the reception channel is less than or equal to a specific threshold, may reselect channel for receiving the signal.

In addition, the cognitive engine may be connected to the positioning unit, and may regulate a period of determining channel quality on the basis of a reception apparatus's moving speed calculated by using a result of the positioning of the reception apparatus.

In addition, the cognitive engine may determine a reliability state of the reception apparatus, and if the reception apparatus is reliable, may receive the GNSS signal by selecting one of reception channels.

In addition, the cognitive engine may be connected to the positioning unit, and may regulate a period of determining reliability on the basis of a reception apparatus's moving speed calculated by using a result of the positioning of the reception apparatus.

### BRIEF DESCRIPTION OF THE DRAWINGS

FIG. 1 is a block diagram showing the conventional global navigation satellite system (GNSS) signal reception apparatus.

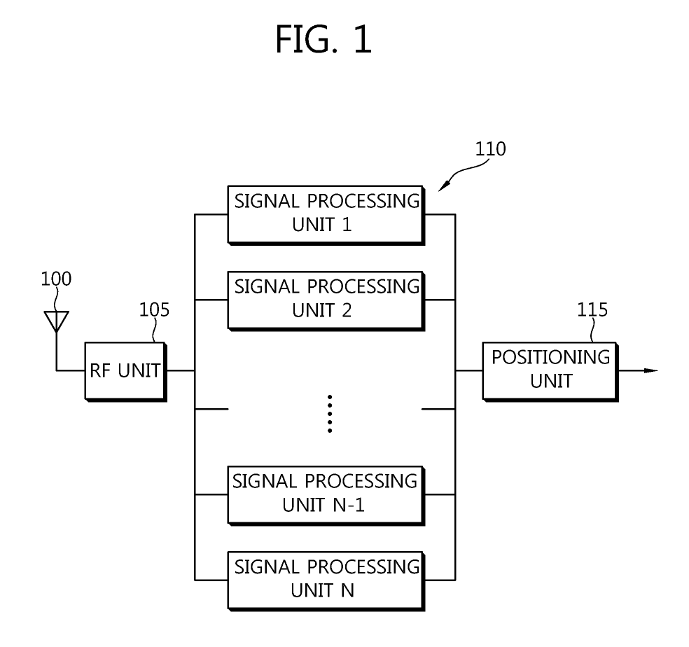

FIG. 2 is a block diagram showing a GNSS signal reception apparatus according to an embodiment of the present invention.

FIG. 3 is a flowchart showing a method of receiving a GNSS signal according to an embodiment of the present invention.

### DESCRIPTION OF EXEMPLARY EMBODIMENTS

The present invention relates to a software defined radio (SDR)-based global navigation satellite system (GNSS) signal reception method capable of recognizing a communication channel environment of a GNSS and thus adaptively reconfiguring a GNSS signal reception environment (or reception apparatus), and also relates to a GNSS signal reception apparatus using the method.

The GNSS is defined as a system for accurately positioning a target located on the ground by using a satellite network. Examples of a currently available GNSS include the global positioning system (GPS) of the United States, GLONASS of Russia, GALILEO of the European Union, etc.

Among them, the GPS of the United States is created first and consists of 24 satellites orbiting the Earth. The GPS has been able to be widely used for civil purposes in various fields ever since the end of the Cold War era.

According to the original plan started in the former Soviet Union, the GLONASS of Russia was planed to be constructed of 24 satellites. However, it is known that the number of satellites currently in operating is about 8 due to a current economic condition or the like of Russia. In case of the GLONASS, frequency division duplex (FDD) is used unlike the GPS, and thus a carrier has a different frequency in each of satellites constituting the system. In addition, a P-code used only for military purposes in the GPS can also be used for civil purposes in the GLONASS.

The GALILEO of the European Union has been planned preferentially for the civil purposes, and consists of 30 satellites.

As such, each of available GNSSs constructs an independent system. Therefore, there is a need for a GNSS signal reception method for the effective use of various GNSSs and an apparatus using the method.

An SDR technique is an open signal processing technique for freely reconfiguring one common hardware platform by using an application software platform (or radio protocol standard) to flexibly cope with various wireless communication environments (i.e., multiple modes, multiple standards, multiple bands, multiple functions, etc.). The SDR technique is defined by several organizations. In ITU-R (M.2063), the SDR technique is defined as a radio or its technique in which radio frequency (RF) operating parameters including a frequency band, a modulation scheme, or output power can be set and controlled in software. In the SDR forum, the SDR technique is defined as a technique in which hardware and software schemes are combined to enable reconfiguration of a radio base station and a user terminal.

In the SDR technique, most functional blocks including an RF portion located after an antenna stage are performed by programmable software modules, unlike the conventional hardware defined radio (HDR) communication system. Therefore, a plurality of radio communication standards can be integrated and accommodated by a single transmission/reception system by simply making a change in software without modification, alternation, or replacement in hardware.

In addition, the SDR technique is not merely limited to conversion of hardware into software, and has a common hardware platform supporting multiple modes, multiple bands, and multiple functions in an RF end and a modular software structure in which each band, mode, and function or other features can be defined in a system side or a user side. In this case, instead of being defined in the system side or the user side, each band, mode, and function or other features can be defined autonomously.

As can be seen in the aforementioned description, the SDR changes a mechanism of using a different hardware platform for each radio access scheme in a transmission apparatus and a reception apparatus which constitute a communication system to a mechanism of supporting a different radio access mode by reconfiguring a common hardware platform into a software platform. That is, the SDR can provide various radio standards on one platform by changing a single hardware platform into a communication system having a specific protocol or a specific purpose through software reconfiguration.

Therefore, in order for a wireless communication system to recognize a frequency resource state and to implement a complex radio communication environment through switching between heterogeneous protocols based on the recognized frequency resource state, integration of a cognitive radio technique and the SDR may be taken into account.

A GNSS signal reception apparatus having a SDR-based cognitive function (or cognitive engine) according to the present invention can have a structure in which an optimal minimum frequency band is received under the instruction of the cognitive engine included in the reception apparatus, and thus can receive a GNSS signal by using the structure.

In doing so, the GNSS signal can be received by selecting a frequency band having the best environment among many available frequency bands which have currently been generated or which are to be generated afterwards, and the GNSS signal reception apparatus can operate precisely and reliably. In addition, as will be described below, when a GNSS reception state is reliable, power consumption of the GNSS signal reception apparatus can be minimized by receiving only a single frequency band.

According to the present invention, as will be described below, a GNSS signal reception method has a loop structure, and thus a GNSS signal can be received adaptively even if there is a change in a channel environment or a reception state of the GNSS signal. In addition, since a frequency band of an available GNSS is ensured reliably every moment and positioning based on GNSS signals provided from different GNSSs is possible, a probability that positioning becomes impossible due to a shadow area is significantly reduced.

Hereinafter, embodiments of the present invention will be described in detail with reference to the accompanying drawings.

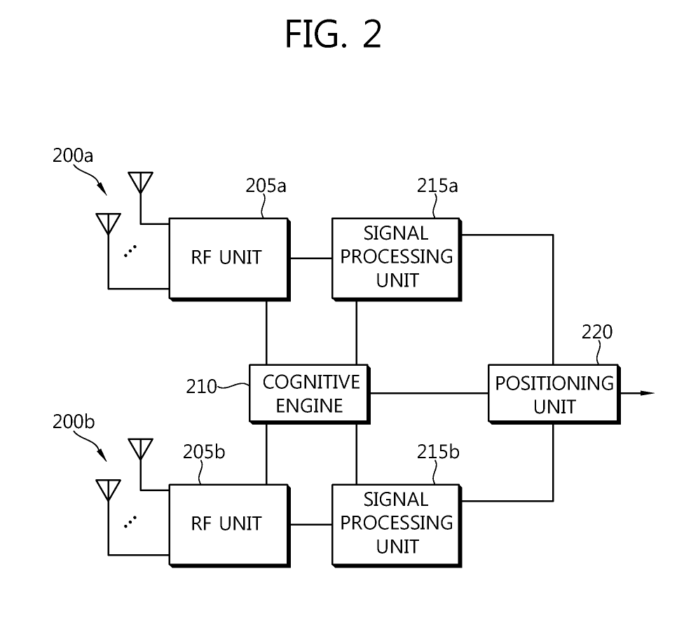

FIG. 2 is a block diagram showing a GNSS signal reception apparatus according to an embodiment of the present invention.

The present invention supports a multiple-carrier system. Antenna units 200a and 200b consist of a plurality of antennas. RF units 205a and 205b receive GNSS signals through the antenna units 200a and 200b. The GNSS signals received through the RF units 205a and 205b are processed into baseband signals by signal processing units 215a and 215b.

When positioning is performed based on a GNSS signal received in a multi-frequency band, an error caused by the ionosphere can be compensated for. Therefore, the present invention can also process frequency-multiplexed GNSS signals by employing the plurality of RF units 205a and 205b and the plurality of signal processing units 215a and 215b.

The GNSS signals processed into the baseband signals in the signal processing units 215a and 215b are delivered to a positioning unit 220 for positioning a current location of the GNSS signal reception apparatus. The positioning unit 220 can calculate not only the current location of the GNSS signal reception apparatus but also a moving speed or the like of the GNSS signal reception apparatus according to the GNSS signal reception apparatus's location measured based on time.

In the GNSS signal reception apparatus of the present invention, the RF unit 205 and the signal processing unit 215 are connected to a cognitive engine 210. The cognitive engine 210 can determine reliability and quality of a reception channel by using a signal received by the RF unit 205. In addition, the cognitive engine 210 can reconfigure the signal processing unit 215 on the basis of the reliability and quality of the reception signal. Reconfiguring of the signal processing unit 215 is based on the SDR technique, and includes defining and configuring of a function required for channel switching and includes changing of an operating parameter or the like according to the reliability and quality of the channel as described above. In addition, the cognitive engine 210 may optionally reconfigure a system of the GNSS signal reception apparatus including not only the signal processing unit 215 but also the RF unit 205.

In addition, the cognitive engine 210 may be connected to the positioning unit 220. The cognitive engine 210 may reconfigure the positioning unit 220 according to channel quality or the like of a signal received by the RF unit 205, and may reconfigure the positioning unit 220 according to a baseband signal processing parameter of the signal processing unit 215. In addition, the cognitive engine 210 may reconfigure the RF unit 205 and the signal processing unit 215 according to the GNSS signal reception apparatus's location or moving speed calculated by the positioning unit 220.

The GNSS signal reception apparatus described in the present embodiment is for exemplary purposes only, and thus the technical features of the present invention are not limited thereto. For example, although it has been disclosed in the present embodiment that the quality or reliability of the reception channel is determined by the cognitive engine 210, this is only for convenience of explanation. Therefore, the quality or reliability of the channel may also be determined by the RF unit 205 or the signal processing unit 215.

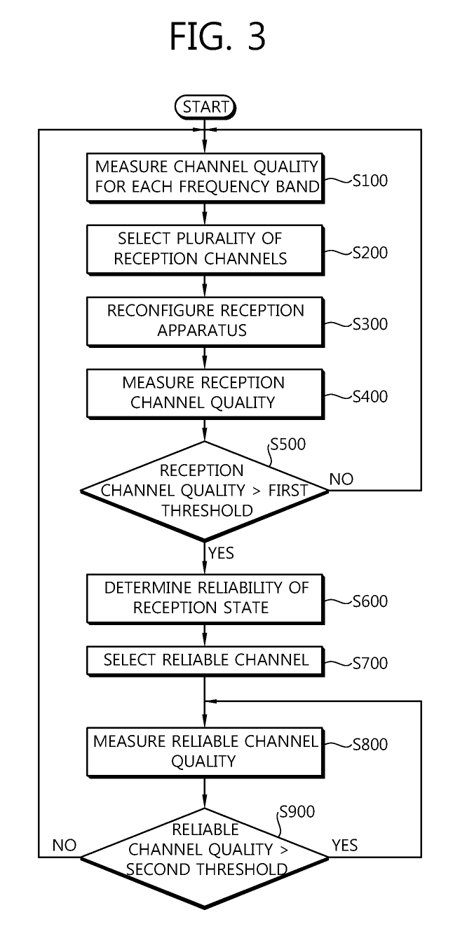

FIG. 3 is a flowchart showing a method of receiving a GNSS signal according to an embodiment of the present invention.

When a GNSS signal reception apparatus is powered on, an operation of the reception apparatus starts. The GNSS signal reception apparatus measures channel quality of a signal received for each frequency band (step S100).

The channel quality per frequency band may be measured by the RF unit 205. Alternatively, the channel quality per frequency band may be measured by the signal processing unit 215 or the cognitive engine 210 by using a signal received by the RF unit 205.

The channel quality per frequency band may be determined by calculating a correct number, or may be determined approximately enough to decide which channel has superior channel quality among channels.

The channel quality per frequency band may be measured by various methods according to a purpose of positioning. For example, various measurement values can be used such as a carrier to noise ratio (CNR) or a signal to noise ratio (SNR) or the like.

After measuring the channel quality per frequency band, a channel having excellent quality is selected based on the measurement value (step S200). In this case, a plurality of channels may be selected for precise positioning. An ionosphere error can be compensated for by processing two or more different baseband signals. Therefore, a plurality of channels (e.g., two channels) may be selected as a reception channel for receiving a GNSS signal.

The GNSS signal reception apparatus is reconfigured in association with the selected reception channel (step S300). If the selected reception channel is optimized to the current GNSS signal reception apparatus or if there is no need to reconfigure the GNSS signal reception apparatus when considering power consumption or the like required for reconfiguration, the current GNSS signal reception apparatus may be used without reconfiguration.

When the GNSS signal reception apparatus is reconfigured in association with the reception channel, the reception apparatus enters a GNSS receptions state (steps S400 to S900).

The channel quality is also measured even after the reception apparatus enters the GNSS reception state by selecting the reception channel (step S400). Quality of the reception channel may be measured in the RF unit 205, or may be measured in the signal processing unit 215 or the cognitive engine 210 by using a signal received through the RF unit 205.

This measurement is performed to determine whether to change or maintain the current reception channel. The quality of the reception channel is measured in detail to be compared with a predetermined threshold.

The quality of the reception channel may be measured by various methods according to a purpose of positioning. For example, various measurement values can be used such as a CNR or an SNR or the like.

The measured quality of the reception channel is compared with the specific threshold (step S500). The specific threshold is a measurement value based on a corresponding measurement means and is a threshold required for reception of a GNSS signal according to the measurement means (e.g., CNR, SNR, etc.) selected based on the purpose of positioning.

A measurement result of the channel quality per frequency band may be different from a measurement result of reception channel quality due to interference or jamming. In addition, due to a condition depending on a difference of a measurement time (i.e., a standby state, an ionosphere state, a positional change, a geographical change, etc.), a channel having good quality in terms of the channel quality per frequency band may not satisfy the standard when measuring the quality by using the reception channel.

If the measurement result of the reception channel quality shows that the channel quality does not satisfy the specific threshold, the channel quality per frequency band is measured again (step S100), a plurality of communication channels having excellent channel quality are selected again (step S200), and the subsequent steps are repeated.

In this case, if even one reception channel among the plurality of reception channels does not exceed the specific threshold, the GNSS signal reception apparatus may repeat a series of steps S100 to S300 to select a new reception channel while excluding all frequency bands corresponding to the plurality of reception channels.

In addition, if some reception channels among the plurality of reception channels do not exceed the specific threshold, only frequency bands of the some reception channels not exceeding the specific threshold may be excluded and then the series of steps S100 and S300 may be repeated to select a reception channel for replacing the excluded channels.

In addition, if some reception channels among the plurality of reception channels do not exceed the specific threshold, the GNSS reception state can be maintained by only the reception channels satisfying the specific threshold as long as there are remaining available reception channels.

If the GNSS signal reception apparatus repeats the series of steps, the cognitive engine 210 reconfigures the GNSS signal reception apparatus according to a result of performing the steps.

If the quality of the reception channel satisfies the specific threshold, reliability of the reception state is determined while maintaining the GNSS reception state (step S600).

A method of determining the reliability of the reception state may be various according to a purpose or application of positioning. For example, there may be a method in which a code phase and/or a carrier phase of a received GNSS signal are measured for a specific time period in the signal processing unit 215 and the measurement result is utilized as a statistical value. In this case, it may be determined that the reception state is reliable if the code phase and/or the carrier phase of the GNSS signal do not change significantly in comparison with a specific threshold or an average value for a specific time period or do change within a specific offset range.

If the reception state is not reliable, the reception state may become reliable over time, or channel quality may deteriorate. Therefore, the procedure may proceed to next steps when the reception state becomes reliable as a result of repeating the reliable measurement, or the series of steps S100 to S300 for selecting the reception channel may be repeated due to deterioration of the channel quality. For this, the GNSS reception apparatus may repetitively perform the step of determining the reliability of the receptions state (step S600) at a specific period, or may perform the step of measuring and determining the reception channel (step S400 and/or step S500) together with the step of determining the reliability of the reception state (step S600). In this case, the cognitive engine 210 also optionally reconfigures the GNSS signal reception apparatus.

If it is determined that the reception state is reliable, one or a plurality of reliable channels are selected from reception channels (step S700). The GNSS signal reception apparatus continuously maintains GNSS reception through the selected reliable channels. Herein, the reliable channel does not imply the most reliable channel among the reception channels but implies a reception channel selected after reception becomes reliable.

A plurality of reliable channels may be selected from the reception channels, or only one channel may be selected by considering power consumption or the like. In addition, the reliable channel may be selected by using various methods and criteria. For example, the reliable channel may be selected according to a preference based on a user's usage history, or a channel having the best channel quality may be selected.

When the reliable channel is selected, the cognitive engine 210 optionally reconfigures the GNSS signal reception apparatus.

Channel quality is also measured for the selected reliable channel (step S800). The channel quality is measured with a specific period or randomly, and is measured persistently.

Quality of the reliable channel may be measured in the RF unit 205. The channel quality may also be measured in the signal processing unit 215 or the cognitive engine 210 by using a signal received through the RF unit 205.

Since this measurement is performed to determine whether to change the current reliable channel, the quality of reception channel is measured in detail to be compared with a predetermined threshold.

The quality of the reception channel may be measured by various methods according to a purpose of positioning. For example, various measurement values can be used such as a CNR, an SNR, or the like.

The measured quality of the reliable channel is compared with the specific threshold (step S900). The specific threshold is a measurement value based on a corresponding measurement means and is a threshold required for reception of a GNSS signal according to the measurement means (e.g., CNR, SNR, etc.) selected by the purpose of positioning.

The quality of the reliable channel may deteriorate due to interference or jamming or due to a condition depending on a difference of a measurement time (i.e., a standby state, an ionosphere state, a positional change, a geographical change, etc.). If the quality of the reliable channel does not satisfy a specific threshold, the channel quality per frequency band is measured again (step S100), a plurality of communication channels having excellent channel quality are selected again (step S200), and the subsequent steps are repeated. If the GNSS signal reception apparatus repeats the series of steps, the cognitive engine 210 optionally reconfigures the GNSS signal reception apparatus.

In this case, if even one reliable channel among the plurality of reliable channels does not exceed the specific threshold, the GNSS signal reception apparatus may repeat a series of steps S100 to S700 to select a new reliable channel while excluding all frequency bands corresponding to all reliable channels.

In addition, if some reliable channels among the plurality of reliable channels do not exceed the specific threshold, only frequency bands of the some reliable channels not exceeding the specific threshold may be excluded and then the series of steps S100 and S700 may be repeated to select a reliable channel for replacing the excluded channels.

In addition, if some reliable channels among the plurality of reliable channels do not exceed the specific threshold, the GNSS reception state can be maintained by only the reliable channels satisfying the specific threshold as long as there are remaining available reliable channels.

The aforementioned method of receiving the GNSS signal has a process different from that of a GNSS-based positioning method, and is a method for maintaining a reliable and high-quality signal.

By considering an aspect of power consumption, the cognitive engine may regulate a period of measurement or determination (i.e., channel quality and/or reliability determination) in the aforementioned method of receiving the GNSS signal. For example, according to a moving speed of the GNSS signal reception apparatus capable of obtaining a result of positioning, if the moving speed is faster than a specific threshold, the period of measurement/determination may be decreased to manage channel quality in accordance with the moving speed, and if the moving speed is slower than the specific threshold, the period of measurement/determination may be increased. In this manner, an amount of power consumption required for measurement/determination can be properly managed.

In the aforementioned channel selection method, a specific candidate frequency band may be predetermined based on performance of the GNSS signal reception apparatus, a place of using the GNSS signal reception apparatus, a user's preference, a user's usage history, etc., and a channel may be selected among channels satisfying respective measurement criteria.

The reconfiguration of the GNSS signal reception apparatus described above according to the present invention includes all required reconfiguration operations adaptively depending on a change in an environment, for example, an operation of determining whether to use a multi-antenna system or a single-antenna system, an operation of regulating the number of available RF units and/or signal processing units in accordance with the number of selected channels, and an operation of reconfiguring an operating parameter of each processor (e.g., an antenna, an RF unit, a signal processing unit, a positioning unit, etc.,) depending on a channel property, and is actively controlled by the cognitive engine of the GNSS reception apparatus.

The present invention provides a method of receiving a global navigation satellite system (GNSS) signal with high quality by adaptively coping with a channel environment.

The present invention also provides a method of reliably receiving a GNSS signal by adaptively coping with a channel environment.

The present invention also provides a method capable of saving manufacturing and operating costs of a reception apparatus by reconfiguring a software defined radio (SDR)-based reception apparatus.

The present invention also provides a method capable of significantly reducing power consumption of a reception apparatus by reconfiguring an SDR-based reception apparatus.

Although a series of steps or blocks of a flowchart are described in a particular order when performing methods in the aforementioned exemplary system, the steps of the present invention are not limited thereto. Thus, some of these steps may be performed in a different order or may be concurrently performed. Those skilled in the art will understand that these steps of the flowchart are not exclusive, and that another step can be included therein or one or more steps can be omitted without having an effect on the scope of the present invention.

The aforementioned embodiments include various exemplary aspects. Although all possible combinations for representing the various aspects cannot be described, it will be understood by those skilled in the art that other combinations are also possible. Therefore, all replacements, modifications and changes should fall within the spirit and scope of the claims of the present invention.

What is claimed is:

1. A method of receiving a global navigation satellite system (GNSS) signal in a GNSS reception apparatus, the method comprising the steps of:
measuring channel quality for each frequency band;
selecting a plurality of reception channels by using the measured channel quality;
reconfiguring an operating parameter of a reception apparatus in accordance with the reception channel; and
receiving a signal by using the reconfigured operating parameter.

2. The method of claim 1, further comprising the steps of:
measuring quality of the reception channel through which the signal is received; and
determining whether a signal reception state is reliable,
wherein if the reception channel′ channel quality measured in the step of measuring the quality of the reception channel is less than a first threshold, returning to the step of measuring channel quality for each frequency band, the respective steps are repeated, and wherein if the reception state is determined to be reliable in the step of determining the stability of the signal reception state, the signal is received by selecting one reliable channel from the reception channels.

3. The method of claim 2, further comprising the step of measuring channel quality for the reliable channel, wherein if the measured channel quality of the reliable channel is less than a second threshold, returning to the step of measuring channel quality for each frequency band, the respective steps are repeated.

4. The method of claim 3, wherein a period of measuring the channel quality of the reliable channel is determined according to a moving speed of the reception apparatus.

5. The method of claim 3, wherein the channel quality of the reliable channel is determined by measuring a signal to noise ratio of the channel.

6. The method of claim 2, wherein if even any one of the reception channels has channel quality less than the first threshold, returning to the step of measuring channel quality for each frequency band, the respective steps are repeated.

7. The method of claim 2,
wherein if channel quality of all of the reception channels is less than the first threshold, returning to the step of measuring channel quality for each frequency band, the respective steps are repeated, and
wherein if channel quality of some of the reception channels is less than the first threshold, a reliable channel is selected from reception channels having channel quality greater than the first threshold.

8. The method of claim 2, wherein quality of the reception channel is determined by measuring a signal to noise ratio.

9. The method of claim 2, wherein the reliability of the reception state is determined according to whether a code phase or a carrier phase of the received signal is maintained within a specific reference offset range during a predetermined specific reference time.

10. The method of claim 1, wherein the step of measuring channel quality for each frequency band is performed for a candidate frequency band which is predetermined according to at least one of criteria including performance of the reception apparatus, a location of the reception apparatus, a previous usage history of the reception apparatus, and a user's preference.

11. The method of claim 1, wherein the step of measuring channel quality for each frequency band determines channel quality by measuring a carrier-to-noise ratio of the channel for each frequency band.

12. An apparatus for receiving a global navigation satellite system (GNSS) signal, the apparatus comprising:
a plurality of radio frequency (RF) units for extracting a baseband signal by receiving the GNSS signal;
a signal processing unit for processing the baseband signal;
a positioning unit for positioning the reception apparatus by using an output value of the signal processing unit; and
a software defined radio (SDR)-based cognitive engine,
wherein the cognitive engine reconfigures the RF unit and the signal processing unit according to a channel environment corresponding to each frequency band of the received signal.

13. The apparatus of claim 12, wherein the cognitive engine reconfigures the RF unit and the signal processing unit by reconfiguring an operating parameter of the GNSS reception apparatus.

14. The apparatus of claim 12, wherein the cognitive engine determines quality of a reception channel through which the reception apparatus receives a signal, and if the quality of the reception channel is less than or equal to a specific threshold, reselects a channel for receiving the signal.

15. The apparatus of claim 14, wherein the cognitive engine is connected to the positioning unit, and regulates a period of determining channel quality on the basis of a reception apparatus's moving speed calculated by using a result of the positioning of the reception apparatus.

16. The apparatus of claim 12, wherein the cognitive engine determines a reliability state of the reception apparatus, and if the reception apparatus is reliable, receives the GNSS signal by selecting one of reception channels.

17. The apparatus of claim 14, wherein the cognitive engine is connected to the positioning unit, and regulates a period of determining reliability on the basis of a reception apparatus's moving speed calculated by using a result of the positioning of the reception apparatus.
